(19) United States
(12) Patent Application Publication
(10) Pub. No.: US 2005/0074214 A1
(43) Pub. Date: Apr. 7, 2005

(54) Method of making a dispersion managed optical cable installation, and cables for use in the method

(76) Inventor: Derek C. Whittingham, Warrington, Cheshire (GB)

Correspondence Address: Timothy J Aberle, PO Box 489, Hickory, NC, 28603-0489, US

(21) Appl. No.: 10/495,911

(22) PCT Filed: Nov. 20, 2002
(86) PCT No.: PCT/EP02/13007

(30) Foreign Application Priority Data
Nov. 20, 2001 (GB) 0127726.8

(51) Int. Cl. G02B 6/44

(52) U.S. Cl. 385/100

(57) ABSTRACT

A method of making an optical cable installation is characterised by the steps of: a) making optical fibre and cutting it to form at least one group of fibres with approximately equal fibre lengths suitable for making a length of cable; b) from the or each such group, measuring the chromatic dispersion value of each fibre and on the basis of that measurement allocating each fibre to a particular subgroup, there being subgroups distinguished by a different range of chromatic dispersion values that is narrow compared with the total range of chromatic dispersion values of the fibres in the group; c) marking each of the fibres to indicate the subgroup to which it belongs; d) making two cables of complementary length or two sets of cables of complementary aggregate length, each cable including at least one fibre from each of selected said subgroups; and e) connecting the fibres of these two cables or sets directly or indirectly according to the subgroups to which they belong so that the aggregate chromatic dispersion of each pair of connected fibres is within a single predetermined band and completing a dispersion-managed installation with at least one length of cable of opposite chromatic dispersion. The present invention provides a practicable and convenient method by which fibres can be selected and organised so that adequate dispersion management can be achieved with a fibre splices only at a small number of locations.

### FIELD OF THE INVENTION

This invention relates to a method of making an optical cable installation for telecommunications, and to cables (and pairs of cables) for use in the method.

### BACKGROUND OF THE INVENTION

The available bandwidth of an optical cable system is often limited by the chromatic dispersion of the optical fibres that it comprises, which results in pulse broadening because the transit time of light of even slightly different wavelengths is not identical, and in the extreme the inability to distinguish pulses as they begin to overlap. In a “dispersion managed” installation, this tendency is countered by taking advantage of the fact that fibres with opposite chromatic dispersion are available, so that pulses that have been broadened by passage through a substantial length of fibre of negative dispersion can be restored to near their original length by passage through a proportionate length of fibre of negative dispersion (and vice versa).

Dispersion management is not that easy, however, because the chromatic dispersion value of a fibre cannot be precisely controlled in manufacture, and the unavoidable variations for currently available negative-dispersion fibres are so large that if cables are simply made with fibres of the same nominal chromatic dispersion value, individual fibres will need different lengths of positive-dispersion fibre to obtain adequate compensation, which is altogether impracticable. It is therefore necessary to make a selection from the available chromatic dispersion values, and the present invention provides a practicable and convenient method by which fibres can be selected and organised so that adequate dispersion management can be achieved with fibre splices only at a small number of locations (usually only at cable joints) and in which a large proportion, if not all, of manufactured fibre can be used.

The method of the invention comprises the steps of:
a) making optical fibre and cutting it to form at least one group of fibres with approximately equal fibre lengths suitable for making a length of cable;
b) from the or each such group, measuring the chromatic dispersion value of each fibre and on the basis of that measurement allocating each fibre to a particular subgroup, there being subgroups distinguished by a different range of chromatic dispersion values that is narrow compared with the total range of chromatic dispersion values of the fibres in the group;
c) marking each of the fibres to indicate the subgroup to which it belongs;
d) making two cables of complementary length or two sets of cables of complementary aggregate length, each cable including at least one fibre from each of selected said subgroups; and
e) connecting the fibres of these two cables or sets directly or indirectly according to the subgroups to which they belong so that the aggregate chromatic dispersion of each pair of connected fibres is within a single predetermined chromatic dispersion-value band and completing a dispersion-managed installation with at least one length of cable of opposite chromatic dispersion.

By “complementary” lengths are meant lengths that are so related to each other and to the respective chromatic dispersion values of the connected fibres that the desired optical result is obtained. In the simplest embodiments the subgroups will be chosen symmetrically in relation to the average chromatic dispersion value and the complementary lengths will be equal lengths, so as to obtain an aggregate chromatic dispersion close to zero: but it is possible to make a different choice of subgroups and still obtain an aggregate chromatic dispersion close to zero by using complementary but different lengths. Furthermore, there may be circumstances in which it is desirable to set a target aggregate chromatic dispersion that differs from zero.

It is not necessary that all the subgroups are different, and in particular may be desirable that they represent substantially equal steps in chromatic dispersion value and are in numbers roughly proportional to the population of those values in the fibre as manufactured. Preferably every chromatic dispersion value found in the fibre as manufactured, except extreme variants, is included in at least one of the subgroups.

We estimate that with current techniques for the manufacture of negative dispersion fibres, about 12 subgroups will be needed if the range of chromatic dispersion values within them is to be narrow enough for its influence on the aggregate chromatic dispersion value to be tolerable, assuming that substantially all manufactured fibre is to be used; but it is possible, depending on the cable design and the number of fibres required, to select less than all the subgroups into which the fibres are formed (but always the same subgroups throughout the installation). Selecting all the subgroups may make it easier to manage stockholding.

Because of the small cross-section of optical fibres, they will normally be marked by a single overall surface colouration, and an exemplary embodiment of the invention will be described in terms of fibre colours; but the use of other means of marking, including means that require the use of instruments to read them, is contemplated as well. For example, inked bands or dashes could be applied to the optical fibres that are machine readable and may be discernible by eye.

Preferably two such groups of fibres, all of substantially the same length, are formed, and are marked differently to each other: more especially, the two groups are marked with the same colours or other markings but in the opposite sequence. The two cables are then to be made using fibres from the respective groups, and the required connections are achieved by connecting fibres of the same marking in the two cables.

It will usually be the case that more than two cables of negative (and/or positive) dispersion will be required to complete the length of the installation, and it is therefore important to know in which sequence the markings are applied; preferably, each cable is marked to indicate its sequence parity.

A possible alternative is to use colour or other marking sequences that are entirely different for the two cables, in the sense that they have no marking in common. It is unlikely that it will be feasible to find more than about 12 colours that are reliably distinguishable by eye, and so if applied to single solid colour markings this would at present depend on selecting only some of the fibre subgroups—say half of them, in which case the other half could be used in a parallel set of cables, for example to be supplied to a different customer. Improvements in manufacturing consistency may at some time eliminate the extreme subgroups and so make this practicable with all the remaining subgroups selected.

Usually the trunk cables to which dispersion management is most relevant will require many more than 12 fibres, and in such cases it is preferable that the fibres are organised into subassemblies, each subassembly being identifiable overall and containing one fibre of each subgroup (each colour). For example, the cable may be of the loose-tube type, with multiple tubes each containing about 12 differently coloured fibres and the tubes themselves individually coloured and/or numbered so that any individual fibre of the cable can be identified. Analogous organisation and marking can be used for “monotube” cables with fibres organised in bundles or ribbons, as well as for slotted core cables.

The following twelve colours are currently used to mark optical fibres (for individualisation only, not in relationship to any property of the fibre) and may be adopted for the purpose of this invention: blue; orange; green; brown; gray; white; red; black; yellow; violet; pink; turquoise.

If the two cables (or the cables of the two sets) of the invention were alike (rather than having their colour sequence reversed as preferred), then the fibres would need to be connected as follows:

| first cable | second cable |
|---|---|
| blue | turquoise |
| orange | pink |
| green | violet |
| brown | yellow |
| gray | black |
| white | red |
| red | white |
| black | gray |
| yellow | brown |
| violet | green |
| pink | orange |
| turquoise | blue |

This is possible, but prone to error.

The invention includes optical fibre cable, being an “intermediate” in the performance of the method of the invention, comprising a plurality of optical fibres and a protective covering, characterised in that the fibres include at least one group that comprises one fibre from each of a plurality of subgroups distinguished by bands of chromatic dispersion values that are narrow compared with the variance of chromatic dispersion values of all the fibres and marked to indicate the subgroup to which they belong.

More especially, it includes a pair of such cables, the markings indicating the subgroups to which the fibres belong being different, and preferred pairs in which the markings are oppositely related to the chromatic dispersion values of the subgroups.

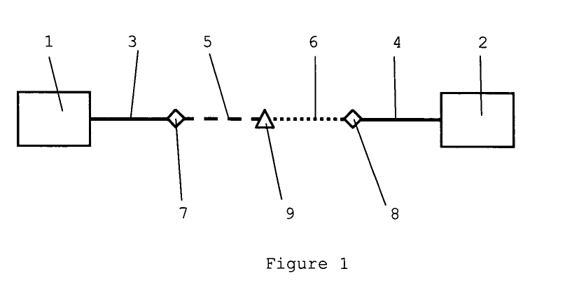

The invention will be further described, by way of example, with reference to the accompanying drawing in which FIG. 1 is a diagram of one “span” of an installation in accordance with the invention.

The installation comprises any required number of spans, each extending from a first node 1 to a second node 2; the nodes will each contain one or more of transmitting, receiving, amplifying, modulating, branching and channel add/drop equipment. The span comprises cables of three different types, each in the required number of sections for practical requirements of manufacture and installation and each containing generally similar fibres in sufficient numbers to accommodate the expected data traffic. In this case there are positive-dispersion cables 3 and 4 at both ends of the span, and two different negative-dispersion cables 5 and 6 between them. References 7 and 8 indicate transition splices between positive- and negative-dispersion fibres, and 9 will be referred to as a “mirror” splice, between two different negative-dispersion fibres that are, in this example, matched to achieve approximately equal aggregate negative dispersion, as will be explained. In addition, there may be plain splices (not shown) between similar fibres wherever cable joints are otherwise necessary or convenient.

The positive-dispersion fibres have a reasonably consistent chromatic dispersion value of +19.2±0.9 μs/m² (or in practical units ps/nm·km) and the negative-dispersion fibres have an average value of about −29.0 μs/m² but individually vary in a range from about −24.2 to −33.8 μs/m². Based on average values, the ratio of the lengths of positive-dispersion cables 3 and 4 to total negative-dispersion cables 5 and 6 is about 29.0/19.2=1.51.

In accordance with the method of the invention, the fibre as manufactured is cut into lengths corresponding to the required individual cable-lengths (for simplicity, it will be assumed that in this example installation they are all equal: otherwise, each required length needs to be planned and processed separately). The actual chromatic dispersion of each cable length is then allocated to dispersion-value bands and coloured in two groups as follows until each subgroup in each group contains, in this example, at least 48 fibres:

| | maximum | minium | average | colour for | colour for |
|---|---|---|---|---|---|
| sub- | dispersion | dispersion | dispersion | first | second |
| group | (μs/m²) | (μs/m²) | (μs/m²) | group | group |
| 1 | −33.8 | −32.2 | −33.0 | blue | turquoise |
| 2 | −32.2 | −30.2 | −31.4 | orange | pink |
| 3 | −32.2 | −30.6 | −31.4 | green | violet |
| 4 | −30.6 | −29.6 | −29.8 | brown | yellow |
| 5 | −30.6 | −29.0 | −29.8 | gray | black |
| 6 | −30.6 | −29.0 | −29.8 | white | red |
| 7 | −29.0 | −27.4 | −28.2 | red | white |
| 8 | −29.0 | −27.4 | −28.2 | black | gray |
| 9 | −29.0 | −27.4 | −28.2 | yellow | brown |
| 10 | −27.4 | −25.8 | −26.2 | violet | green |
| 11 | −27.4 | −25.8 | −26.2 | pink | orange |
| 12 | −25.4 | −24.2 | −25.0 | turquoise | blue |

It will be noted that certain of these groups (for example groups 4, 5 and 6) only differ in colour, reflecting the relative frequencies of different values, which are roughly Gaussian: it would be possible to define them with closer and mutually exclusive (or overlapping, but different) limits.

A first set of loose-tube cable lengths (“standard” cables) is made by inserting into each of four tubes one fibre from each of the subgroups of the first group and assembling those tubes into cable in an entirely conventional manner; a second set of cable lengths (“mirror” cables) is made similarly using in each tube one fibre from each subgroup of the second group.

By using cable lengths from the first set as the negative-dispersion cables 5 and equal aggregate cable lengths from the second set as negative-dispersion cables 6 and connecting fibres of the same colour throughout, an average chromatic dispersion of −29.0±3.2 μs/m² is obtained for every individual fibre over the whole negative-dispersion part of the span.

An additional advantage of using this invention to make a cable installation is that it is possible to hold in stock a spare length of each of the three cable types, in confidence that it will be suitable to replace a portion of the original cable of that type that may be damaged.

Any discussion of the background to the invention herein is included to explain the context of the invention. Where any document or information is referred to as “known”, it is admitted only that it was known to at least one member of the public somewhere prior to the date of this application. Unless the content of the reference otherwise clearly indicates, no admission is made that such knowledge was available to the public or to experts in the art to which the invention relates in any particular country (whether a member-state of the PCT or not), nor that it was known or disclosed before the invention was made or prior to any claimed date. Further, no admission is made that any document or information forms part of the common general knowledge of the art either on a world-wide basis or in any country and it is not believed that any of it does so.

1. A method of making an optical cable installation characterised by the steps of:
a) making optical fibre and cutting it to form at least one group of fibres with approximately equal fibre lengths suitable for making a length of cable;
b) from the or each such group, measuring the chromatic dispersion value of each fibre and on the basis of that measurement allocating each fibre to a particular subgroup, there being subgroups distinguished by a different range of chromatic dispersion values that is narrow compared with the total range of chromatic dispersion values of the fibres in the group;
c) marking each of the fibres to indicate the subgroup to which it belongs;
d) making two cables of complementary length or two sets of cables of complementary aggregate length, each cable including at least one fibre from each of selected said subgroups; and
e) connecting the fibres of these two cables or sets directly or indirectly according to the subgroups to which they belong so that the aggregate chromatic dispersion of each pair of connected fibres is within a single predetermined chromatic dispersion value band and completing a dispersion-managed installation with at least one length of cable of opposite chromatic dispersion.

2. A method of making a cable installation as claimed in claim 1, wherein the subgroups represent substantially equal steps in chromatic dispersion value and are in numbers roughly proportional to the population of those values in the fibre as manufactured.

3. A method of making a cable installation as claimed in claim 1, wherein every chromatic dispersion value found in the fibre as manufactured, except extreme variants, is included in at least one of the subgroups.

4. A method as claimed in claim 1, wherein the said subgroups are selected symmetrically in relation to the average chromatic dispersion value and the complementary lengths are equal lengths.

5. A method of making a cable installation as claimed in claim 1, wherein the fibres are negative dispersion fibres comprising using about 12 subgroups.

6. A method of making a cable installation as claimed in claim 1, wherein the optical fibres are each marked by a single overall surface colouration.

7. A method of making a cable installation as claimed in claim 1, wherein at least one optical fibre is marked by bands or dashes.

8. A method of making a cable installation as claimed in claim 1, wherein comprising forming two such groups of fibres, all of substantially the same length, and marking them differently to each other.

9. A method of making a cable installation as claimed in claim 8, wherein the two groups are marked with the same colours or other markings but in the opposite sequence with respect to chromatic dispersion values and the two cables are made using fibres from the respective groups, so that the required connections are achieved by connecting fibres with the same markings in the two cables or sets of cables.

10. A method of making a cable installation as claimed in claim 9, wherein each cable is marked to indicate its marking sequence parity.

11. A method of making a cable installation as claimed in claim 1, wherein the cables have many more than 12 fibres and in which the fibres are organised into subassemblies, each subassembly being identifiable overall and containing one fibre of each selected subgroup.

12. A method of making a cable installation as claimed in claim 11, wherein at least one cable is of the loose-tube type and comprises multiple tubes each containing about 12 differently coloured fibres and the tubes themselves individually coloured and/or numbered so that any individual fibre of the cable can be identified.

13. A method of making a cable installation as claimed in claim 1, wherein at least some of the colours blue, orange, green brown, gray, white, red, black, yellow, violet, pink, and turquoise are used to mark the fibres.

14. A method of making a cable installation as claimed in claim 13, wherein the said colours are applied to the fibres of at least one cable in ascending order of chromatic dispersion value.

15. A method of making a cable installation as claimed in claim 13, wherein the said colours are applied to the fibres of at least one cable in descending order of chromatic dispersion value.

16. An optical fibre cable comprising a plurality of optical fibres and a protective covering, wherein the fibres include at least group that comprises one fibre from each of a plurality of subgroups distinguished by bands of chromatic dispersion values that are narrow compared with the variance of chromatic dispersion values of all the fibres and marked to indicate the subgroup to which they belong.

17. An optical cable as claimed in claim 16, comprising at least two such groups of fibres, distinguished according to the same subgroups.

18. An optical cable as claimed in claim 14, which is of the loose-tube type and comprises multiple tubes each containing about 12 differently coloured fibres and the tubes themselves individually coloured and/or numbered so that any individual fibre of the cable can be identified.

19. An optical cable as claimed in claim 16, wherein at least some of the colours blue, orange, green brown, gray, white, red, black, yellow, violet, pink, and turquoise are used to mark the fibres.

20. An optical cable as claimed in claim 16, wherein the said colours are applied to the fibres in ascending order of chromatic dispersion value.

21. An optical cable as claimed in claim 16, wherein the said colours are applied to the fibres in descending order of chromatic dispersion value.

22. A pair of optical cables, each as claimed in claim 16, but with the markings identifying the subgroups being different.

23. A pair of cables as claimed in claim 22, wherein the markings are oppositely related to the chromatic dispersion values of the subgroups.
